(19) United States
(12) Patent Application Publication
(10) Pub. No.: US 2015/0185827 A1
(43) Pub. Date: Jul. 2, 2015

(54) TECHNIQUES FOR PERFORMING SOCIAL INTERACTIONS WITH CONTENT

(71) Applicant: Linkedln Corporation, Mountain View, CA (US)

(72) Inventor: Sameer Sayed, San Ramon, CA (US)

(73) Assignee: Linkedln Corporation, Mountain View, CA (US)

(21) Appl. No.: 14/145,220

(22) Filed: Dec. 31, 2013

(51) Int. Cl. G06F 3/01

(52) U.S. Cl. CPC G06F 3/011; G06F 3/013

(57) ABSTRACT

A method of issuing commands to applications based on movements of users is disclosed. It is detected that a user is interacting with an application executing on a device of the user. A notification is received. The notification indicates that the device has detected a movement of the user. It is determined that the movement represents an intention of the user to issue a command to the application. The command is issued to the application based on the movement.

### TECHNICAL FIELD

This application relates generally to the technical field of implementing user interfaces for mobile devices and, in one specific example, to allowing a user to use bodily movements to issue commands to an application executing on a mobile device of the user.

### BACKGROUND

Some mobile devices, including wearable computing devices, such as Google Glass and Pebble smart watch, may not be controllable by various external input devices, such as mice and keyboards, that are used to control other devices, such as personal computers. For example, a smart phone, such as an iPhone 5, may include a touchscreen and provide a keyboard user interface that allows the user to enter text on the smart phone via the touchscreen as if the user was entering the text using a keyboard or tap on the touchscreen to simulate a clicking of a button on a mouse. However, some mobile devices may lack a touchscreen or be too small in size for such touchscreen input to be feasible. Additionally, even in mobile devices with sizable enough touchscreens, there may be instances where it is not convenient for the user to utilize the touchscreen, such as in direct sunlight when the screen is not visible and when the user cannot perform the necessary precision in hand movement necessary to utilize the touchscreen, such as while driving. Thus, other methods of providing input to these mobile devices may have value.

### BRIEF DESCRIPTION OF THE DRAWINGS

Some embodiments are illustrated by way of example and not limitation in the figures of the accompanying drawings in which:

FIG. 1 is a network diagram depicting a client-server system, within which various example embodiments may be deployed;

FIG. 2 is a block diagram illustrating example modules that may implement various example embodiments;

FIG. 3 is a flow chart illustrating example operations of a method of issuing a command to an application executing on a device of a user based on a monitoring of patterns of eye movements of the user;

FIG. 4 is a flow chart illustrating example operations of a method of issuing a command to an application executing on a device of a user based on a monitoring of patterns of movements of the user;

FIG. 5 is a flow chart illustrating example operations of a method of issuing a command on behalf of a user to share content with an additional user;

FIG. 6 is a flow chart illustrating example operations of a method of controlling an aspect of a device of a user based on a combination of a voice command and a movement; and

FIG. 7 is a block diagram of a machine in the example form of a computer system within which instructions for causing the machine to perform any one or more of the operations or methodologies discussed herein may be executed.

### DETAILED DESCRIPTION

In the following description, for purposes of explanation, numerous specific details are set forth in order to provide an understanding of various embodiments of the inventive subject matter. It will be evident, however, to those skilled in the art, that embodiments may be practiced without these specific details. Further, to avoid obscuring the inventive concepts in unnecessary detail, well-known instruction instances, protocols, structures, and techniques have not been shown in detail. As used herein, the term “or” may be construed in an inclusive or exclusive sense, the term “user” may be construed to include a person or a machine, and the term “interface” may be construed to include an application program interface (API) or a user interface.

In various embodiments, a method of issuing commands to applications based on movements of users is disclosed. It is detected that a user is interacting with an application executing on a device of the user. A notification is received. The notification indicates that the device has detected a movement of the user. It is determined that the movement represents an intention of the user to issue a command to the application. The command is issued to the application based on the movement.

This method and other methods or embodiments disclosed herein may be implemented by a computer system having one or more modules (e.g., hardware modules or software modules). Such modules may be executed by one or more processors of the computer system. This method and other methods or embodiments disclosed herein may be embodied as instructions stored on a machine-readable medium that, when executed by one or more processors, cause one or more processors to perform the instructions.

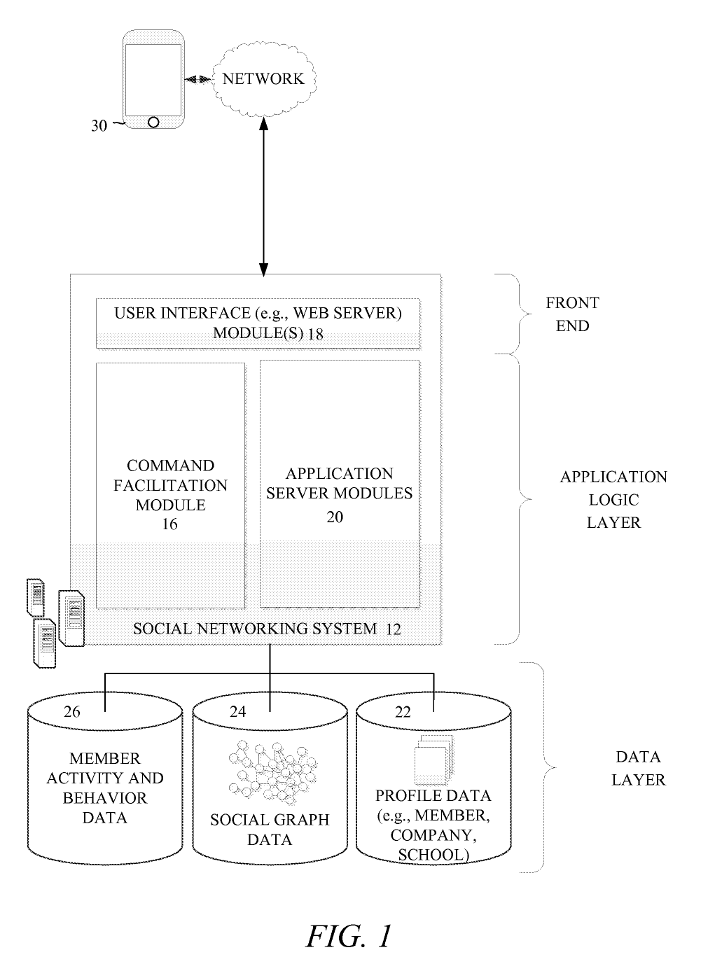

FIG. 1 is a network diagram depicting a server system (e.g., social networking system 12) that includes a command facilitation module 16 for responding to requests or commands received from a mobile computing device 30, consistent with some embodiments of the present invention. As described in greater detail below, the command facilitation module 16 receives commands or requests from mobile computing devices, such as that with reference number 30 in FIG. 1. In various embodiments, the command or request may include information, such as a member identifier uniquely identifying a member of the social networking service (e.g., corresponding to a user of the mobile computing device 30), location information identifying a member's current location, an activity identifier identifying a member's current activity state, and so on. Accordingly, the command facilitation module 16 may perform an action on behalf of the user based in part on the information received with the command or request.

As shown in FIG. 1, the social networking system 12 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such an architecture.

As shown in FIG. 1, the front end layer consists of a user interface module (e.g., a web server) 18, which receives requests from various client-computing devices including one or more mobile computing devices 30, and communicates appropriate responses to the requesting client computing devices. For example, the user interface module(s) 18 may receive requests in the form of Hypertext Transport Protocol (HTTP) requests, or other web-based, application programming interface (API) requests. The client devices may be executing conventional web browser applications, or applications that have been developed for a specific platform to include any of a wide variety of mobile computing devices and mobile-specific operating systems.

As shown in FIG. 1, the data layer includes several databases, including a database 22 for storing data for various entities of the social graph, including member profiles, company profiles, educational institution profiles, as well as information concerning various online or offline groups. Of course, with various alternative embodiments, any number of other entities might be included in the social graph, and as such, various other databases may be used to store data corresponding with other entities.

Consistent with some embodiments, when a person initially registers to become a member of the social networking service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database with reference number 22.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases.

As members interact with various applications, content, and user interfaces of the social networking system 12, information relating to the member's activity and behavior may be stored in a database, such as the database with reference number 26.

The social networking system 12 may provide a broad range of other applications and services that allow members the opportunity to share and receive information, often customized to the interests of the member. For example, with some embodiments, the social networking system 12 may include a photo sharing application that allows members to upload and share photos with other members. With some embodiments, members of a social networking system 12 may be able to self-organize into groups, or interest groups, organized around a subject matter or topic of interest. With some embodiments, members may subscribe to or join groups affiliated with one or more companies. For instance, with some embodiments, members of the social networking service 12 may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with the social graph data of the database with reference number 24.

The application logic layer includes various application server modules 20, which, in conjunction with the user interface module(s) 12, generates various user interfaces with data retrieved from various data sources or data services in the data layer. With some embodiments, individual application server modules 20 are used to implement the functionality associated with various applications, services and features of the social networking system. For instance, a messaging application, such as an email application, an instant messaging application, or some hybrid or variation of the two, may be implemented with one or more application server modules 20. A photo sharing application may be implemented with one or more application server modules 20. Similarly, a search engine enabling users to search for and browse member profiles may be implemented with one or more application server modules 20. Of course, other applications and services may be separately embodied in their own application server modules 20.

As illustrated in FIG. 1, one application server module is a command facilitation module 16. Accordingly, the command facilitation module 16 may facilitate the issuing of commands by the user, as will be described in more detail below.

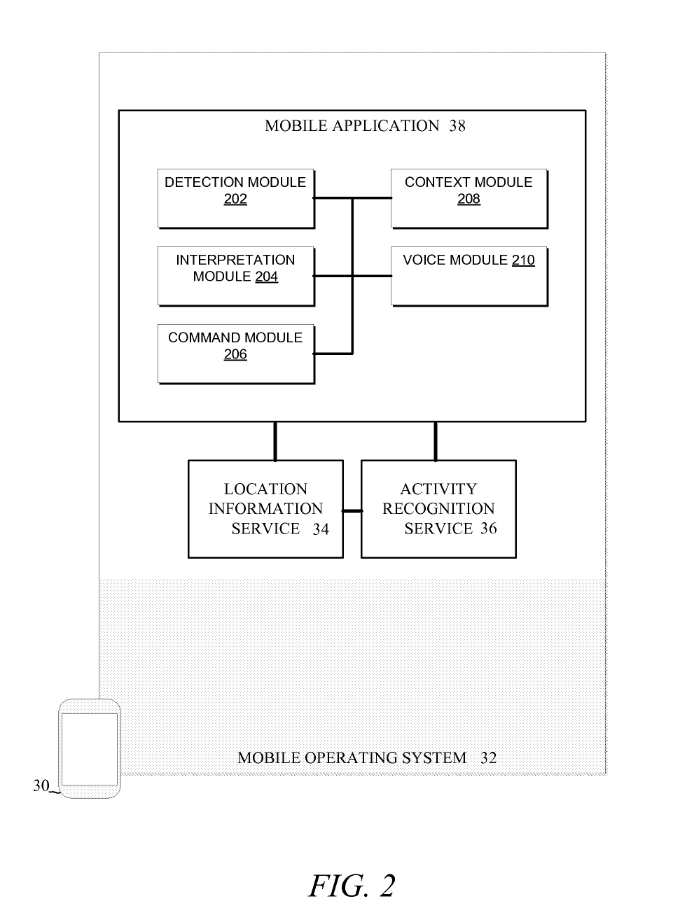

FIG. 2 is a functional block diagram depicting some of the functional modules of a mobile computing device 30, consistent with some embodiments of the invention. As is understood by skilled artisans in the relevant computer- and mobile device-related arts, each module or engine shown in FIG. 2 represents a set of executable software instructions and the corresponding hardware (e.g., memory, processor, sensor devices) for executing the instructions, and deriving or generating relevant data. To avoid obscuring the inventive subject matter with unnecessary detail, various functional modules and engines that are not germane to conveying an understanding of the inventive subject matter have been omitted from FIG. 2.

As illustrated in FIG. 2, the mobile computing device 30 includes a mobile operating system 32, which has both a location information service (or, module) 34 and an activity recognition service (or, module) 36. With some embodiments, one of these two services may be a sub-component of the other, or may be combined as a single service or module. In any case, the services 34 and 36 provide an application-programming interface (API) that allows the mobile application 38 to invoke various functions, or access certain data, that are provided and/or derived by the respective services. For example, the location information service 34 may operate with one or more location sensing components or devices (e.g., a GPS component, WiFi® triangulation, iBeacons or other indoor positioning systems, and so forth) to derive location information representing the current location of the mobile computing device 30, as well as the current speed and direction of travel. The mobile application 38, by making an API request to the location information service 34, can obtain this location information (e.g., current location, direction and speed of travel, etc.) of the mobile computing device. Accordingly, with some embodiments, the location information can be included with a content request communicated to a content server, thereby allowing the content server to select content items based at least in part on the current location of the user, or the current location and direction and speed of travel.

With some embodiments, the activity recognition service 36 may be configured to receive information or data signals from one or more motion sensing components or devices, such as an accelerometer, compass, and/or gyroscope. In addition, the activity recognition service may receive location information from a location sensing component or device, such as a GPS component, indoor positioning system (or other location sensing component), and/or a wireless network interface. By analyzing the information or data signals generated by these various sensing components, the activity recognition service 36 can generate information representing the inferred physical activity state of the member of the social networking service. For example, the various sensing components may generate a combination of signals from which the activity recognition service can infer a particular activity state of the member, to include, but certainly not to be limited to: walking, running, sitting, standing, driving in a vehicle, and riding in a vehicle.

With some embodiments, the inferred physical activity state of the member may be represented by a single activity status identifier that is assigned a particular value to represent the most likely current physical activity state of the member (e.g., walking=1, running=2, sitting still=3, standing=4, etc.). In other embodiments, each of several activity status identifiers may be assigned a value or score representing a measure of the likelihood that a member is in a certain physical activity state (e.g., walking=0.90, running=0.45, sitting still=0.03, standing=0.11, etc.). In yet other embodiments, the inferred physical activity state of the member may be represented by a single activity status identifier that is assigned a particular value to represent the most likely current physical activity state of the member, in combination with another value that represents the likelihood or probability that the member is in the inferred physical activity state (e.g., activity state identifier=1, confidence level=0.90). Of course, an activity status identifier may be encoded in any of a number of other ways as well.

Accordingly, when a user of the mobile computing device is walking, an accelerometer, gyroscope and compass will generally detect motion (and direction) consistent with such activity. An activity status identifier may be assigned a particular value (e.g., a number) that identifies the member's current physical activity state, for example, walking or running. Alternatively, a specific activity status identifier for walking may be assigned a value or score representing the probability or likelihood that the member is at that moment engaged in the particular physical activity—that is, for example, walking. Similarly, when a user places his or her mobile computing device flat on a desk or table top, the sensing components will generally detect motion (or lack thereof) that is consistent with such activity.

In some instances, in addition to signals generated by an accelerometer, gyroscope and/or compass, the activity recognition service 36 may also analyze information received from other data sources, to include information from one or more location sensing components (e.g., GPS, iBeacon, etc.). By analyzing location information, including the current location (e.g., latitude and longitude coordinates) as well as the direction and speed of travel, the activity recognition service 36 can make meaningful inferences about the member's current activity state. For example, an accelerometer and gyroscope of a mobile computing device may detect motion consistent with a member that may be running, while the member's current location, speed and direction of travel, as evidenced by information received via a GPS component, may indicate that the member is currently on a well-known trail or path, and moving in a direction and speed consistent with the member running on the trail or path. Accordingly, the more information from which the activity status identifier is inferred, the higher the confidence level may be for the particular inferred activity status identified.

With some embodiments, the activity recognition service 36 may use a mobile computing device's network activity status to determine the member's current physical activity state. For example, if a mobile computing device is currently paired and actively communicating with another Bluetooth® device known to be in an automobile or vehicle of the member, and the other sensors are detecting signals consistent with the mobile computing device being within a moving automobile or vehicle, the activity recognition service 36 may indicate a high probability that the member is currently driving. Similarly, if the sensors are detecting signals consistent with the mobile computing device being within a moving automobile or vehicle, but the mobile computing device is not currently paired or connected with a known data network (Bluetooth®, personal area network, controller area network, etc.), the activity recognition service 36 may indicate a high probability that the member is currently riding, but not driving, in a vehicle.

With some embodiments, a mobile application 38 may register a request with the activity recognition service 36 to receive periodic updates regarding the inferred activity state of the user of the mobile computing device 30 who is a member of the social networking service. Accordingly, after receiving the request, the activity recognition service 36 may periodically communicate information to the mobile application 38 about the user's inferred activity state. With some embodiments, the activity recognition service 36 may only provide the mobile application 38 with information concerning the current inferred activity status when there is a change from one status to another, or, when the confidence level for a particular activity status exceeds some predefined threshold. In other embodiments, the mobile application 38 may periodically poll the activity recognition service 36 for the current inferred activity state.

Referring again to FIG. 2, the mobile application 38 includes various modules 202-210. A detection module 202 may be configured to detect actions of a user (e.g., movements, gestures, voice commands, and so on). An interpretation module 204 may be configured to interpret an action of the user as an intention by the user to control the mobile device (e.g., issue a command to an application executing on the mobile device). A command module 206 may be configured to execute the user's intended command. A context module 208 may be configured to determine a context of the user when a movement of the user is detected (e.g., which device the user is using, which application within the device currently has focus, and so on). A voice module 210 may be configured to receive voice commands from a user. The interpretation module 204 may be further configured to interpret combinations of voice commands and movements by the user as an issuance of a command by the user.

Although the functionality corresponding to modules 202-210 is depicted and described as being implemented on the client side (e.g., by the mobile application 38), in various embodiments, some or all of the functionality corresponding to modules 202-210 may be implemented on the server side (e.g., by the command facilitation module 16). Thus, in various embodiments, one or more algorithms implemented on the client side or server side may utilize information collected about the user, such as the member's current activity, current location, current gesture, past activity and behavior, social/graph data, profile data, and so on, to facilitate the issuing of a command by the user.

Such commands may particularly be commands that the user intends to invoke with respect to the social networking system 12, such as logging in or out of an account associated with the social networking system 12; declaring or acknowledging a relationship with an additional user of the social networking system 12 (e.g., in various embodiments, the additional user may be identified based on proximity of the user to the additional user), sharing a status update, responding to (e.g., “liking”) posted content items (e.g., a status of another user, a link posted by another user, a news article posted on a forum, and so on), requesting to join or leave a group or group discussion, viewing a profile of the user or an additional user, editing a profile of the user, sending a message to or responding to a message from an additional user, endorsing an additional user (e.g., endorsing qualifications of the additional user for a job), search for candidates having qualifications that meet certain criteria (e.g., candidate matching), apply for a job (e.g., submit a resume maintained by the user with respect to the social networking system to an additional user who is seeking candidates for the job), request to follow postings of an additional user or entity, search for job postings (e.g., recent job postings having criteria that match the user's qualifications), posting a link and/or a comment pertaining to a content item (e.g., a news article), exchanging business cards, and so on.

In various embodiments, the user may link particular activities, movements, gestures, or other actions of the user to particular commands of the social-networking system that the user wishes to invoke. For example, the user may link a thumbs-up gesture of his right hand to a command that invokes a “liking” of a content item (e.g., a status update, a newsfeed posting, and so on) that the user is currently consuming (e.g., browsing or otherwise interacting with) with respect to the social-networking system 12. Or the user may link a particular action or combination of actions (e.g., a pointing gesture and a winking) made in the direction of an additional user of the social networking system with a command that invokes a declaration of a particular relationship with the additional user (e.g., a declaration or acknowledgment that the additional user is a friend or a business connection). Or the user may link detected actions directed to an additional user (e.g., a handshake with the additional user) to a command requesting that the additional user exchange an electronic business card with the user. The linking of detected actions to particular social-networking commands associated with the social-networking system 12 may be allowed by modules executing on the social networking system 12 or the mobile application 38. For example, the modules may provide the user with a user interface for linking particular detected actions of the user (e.g., bodily movements, gestures, and so on) with particular commands that the user may execute with respect to the social networking system. Later, when those linked actions are performed by the user, the modules may interpret the actions as an intention by the user to execute the particular linked commands.

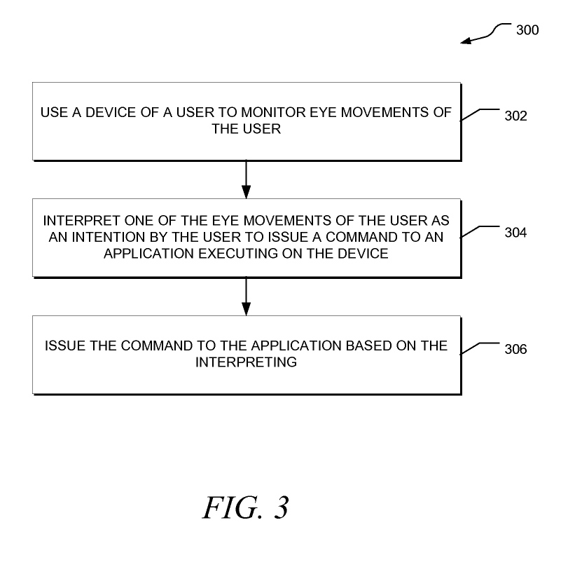

FIG. 3 is a flow chart illustrating example operations of a method 300 of issuing a command to an application executing on a device of a user based on a monitoring of patterns of eye movements of the user. In various embodiments, the method 300 is implemented by the modules 202-210 of FIG. 2. At operation 302, the detection module 202 monitors patterns of eye movements of the user. Such eye movements may include voluntary or involuntary movements of the eye of the user. Such eye movements may include tracking movements, including smooth pursuit, vergence shifts, and saccedes. Such eye movements may include eye movements classified as ductions, versions, or vergences. In various embodiments, the detection module 202 receives data pertaining to eye movements of the user from a wearable computing device, such as Google glass. For example, the wearable computing device may have a camera oriented toward the face of the user and configured to stream data pertaining to video capture of movements of the user's eyes to the detection module 202. Or the wearable computing device may have another sensor, such as an infrared sensor that is configured to detect the movements of the user's eyes.

At operation 304, the interpretation module 204 interprets one of the observed patterns of eye movements of the user as an intention by the user to issue a command with respect to an application executing on a device of the user. In various embodiments, the interpretation module 204 maintains a database of previously-observed patterns of eye movements. The interpretation module 204 may maintain a mapping of observed patterns of eye movements of the user to the previously-observed patterns of eye movements. The previously-observed patterns of eye movements may, in turn, be linked to commands that may be executed within an application executing on a device of the user. In various embodiments, the interpretation module 204 provides a user interface via which the user or and administrator may specify the mappings of eye movements to commands.

As an example, a user may use an application (e.g., a web browser or news reader application) executing on a device of the user to view a content item (e.g., a posting on a social networking site, such as LinkedIn). The application may be configured to allow the user to specify that he “likes” the content item (e.g., by clicking on a “Like” button associated with the posting). The detection module 202 may receive data pertaining to patterns of eye movements of the user while the user is viewing the posting. The interpretation module 204 may interpret one of the patterns as matching a previously-observed pattern that corresponds to a winking of the right of the user. The interpretation module 204 may further be configured (e.g., by the user or an administrator) to interpret the winking of the right eye of the user as an intention by the user to issue the command within the application to indicate a “liking” of the content item that the user is currently viewing.

At operation 306, the command module 206 handles the issuing of the command within the application. For example, the command module 206 controls the application via an API of the application. Or the command module 206 performs an action on behalf of the user to simulate a performance of an action by the user on the device that is to trigger the command within the application. For example, the command module 206 controls the device such that a cursor is moved over a “Like” button of the application and the “Like” button is clicked on behalf of the user. Thus, a user who is executing an application on a device that does not support input devices such as a keyboard or mouse may nevertheless use eye movements to control the device to issue commands within the application, such as those otherwise requiring a moving of a cursor or clicking of a button within an application.

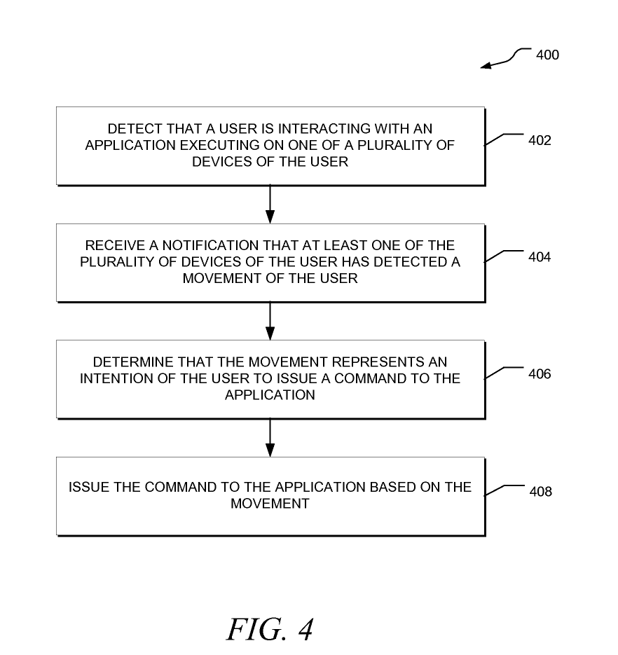

FIG. 4 is a flow chart illustrating example operations of a method 400 of issuing a command to an application executing on a device of a user based on a monitoring of patterns of movements of the user. In various embodiments, the method 400 is implemented by the modules 202-210 of FIG. 2. At operation 402, the detection module 202 detects that a user is interacting with an application executing on one of a plurality of devices of the user. For example, the detection module 202 may detect that the user is interacting with an application executing on a wearable computing device, such as Google Glass, that provides a user interface for viewing profiles of users of a social networking site, such as LinkedIn.

At operation 404, the detection module 202 receives a notification that at least one of the plurality of devices of the user has detected a movement of the user. For example, the detection module 202 may receive a notification from a smart watch that a user has made a gesture with the arm on which the user is wearing the smart watch (e.g., based on a detection of a motion sensor of the watch). Alternatively, a wearable computing device, such as Google Glass, may detect that a use has made a particular expression with his face, such as a winking of the left or right eye (e.g., based on data captured via a sensor of the wearable computing device). Alternatively, the wearable computing device may detect that the user has made a nodding motion with his head (e.g., based on a triggering of an accelerometer or gyroscope of a device worn by the user). Alternatively, the wearable computing device may detect that the user has moved his body or a part of his body based on location information. Alternatively, the wearable computing device may detect that the user has moved based on activity information. Alternatively, the wearable computing device may detect that the user has moved based on any combination of information collected by sensors of the device or services executing on the device. In various embodiments, the detection of the motion may be based on communications received from multiple devices worn by the user, held by the user, or otherwise able to detect motions of the user.

At operation 406, the interpretation module 204 may determine that the detected movement represents an intention of the user to issue a command to the application. For example, the interpretation module 204 may determine that a nodding movement by the user is an indication that the user of a social networking site wishes to send a request to an additional user of the social networking site based on the user performing the nodding movement while viewing the profile of the user in the user interface of an application executing on a wearable computing device of the user. For example, if the user is using an application executing on Google Glass to view a profile of an additional user of LinkedIn, the interpretation module 204 may determine that a nodding movement of the user means that the user wishes to send a request to the additional user to form a connection via LinkedIn. Or, if the user is browsing content on a web browser application executing on a wearable computing device, the interpretation module 204 may determine that the movement of the user means that the user wishes to share the content he is currently viewing via a wall of his social network (e.g., via his wall on Facebook or LinkedIn). The interpretation module 204 may determine which movements correspond to which commands based on a mapping of the movements to the commands, as described above.

At operation 408, the command module 206 may issue the command to the application. For example, if the interpretation module 202 determines that the user wishes to use the currently executing application to send a connect request to an additional user with respect to a social networking site, the command module 206 may initiate the command (e.g., issue a command via an API of the application or use operating system commands of a device of the user to control a user interface of the application).

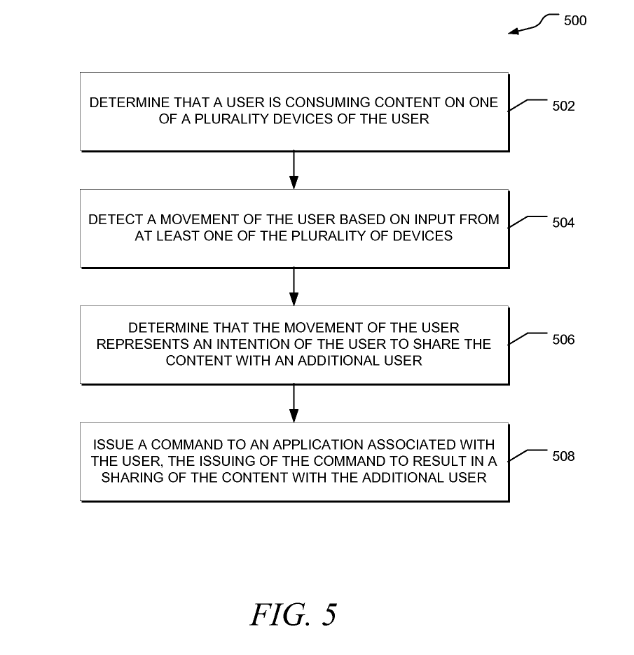

FIG. 5 is a flow chart illustrating example operations of a method 500 of issuing a command on behalf of a user to share content with an additional user. In various embodiments, the method 500 is implemented by the modules 202-210 of FIG. 2. At operation 502, the detection module 202 determines that a user is consuming content on one of a plurality of devices of the user. For example, the detection module 202 may determine that a user is browsing content of a web site using an application executing on a smart phone, smart watch, Google Glass, or other device of the user.

At operation 504, the detection module 202 detects a movement of the user based on input from at least one of the plurality of devices. For example, the detection module 202 may receive a notification from one of the plurality of devices that the user made a gesture, made an expression, moved a part of his body, moved his whole body, nodded, winked an eye, or performed any of a plurality of movements having a pattern that is recognizable by the detection module (e.g., based on a pattern recognition).

At operation 506, the interpretation module 204 determines that the movement of the user represents an intention of the user to share the content with an additional user. For example, the interpretation module 204 may determine that a nodding by the user means that the user wishes to post a link to the content on a wall of the user on a social networking site (e.g., LinkedIn or Facebook). In various embodiments, the link that the user posts on his wall may be other users, such as users having a specified relationship with the user (e.g., friends, connections, or followers of the user).

At operation 508, the command module 206 issue a command to an application associated with the user, the issuing of the command to result in a sharing of the content with the additional user. For example, if the user is using a web browser executing on a device of the user to browse a news story, the command module 206 may issue a command (e.g., via an API) to a social networking site to share a link to the news story on the wall of the user. Or the command module may issue a command to an operating system of the device to copy the news story to a shared folder (e.g., a cloud folder, such as a Dropbox folder) that may be configured to be accessible by one or more additional users.

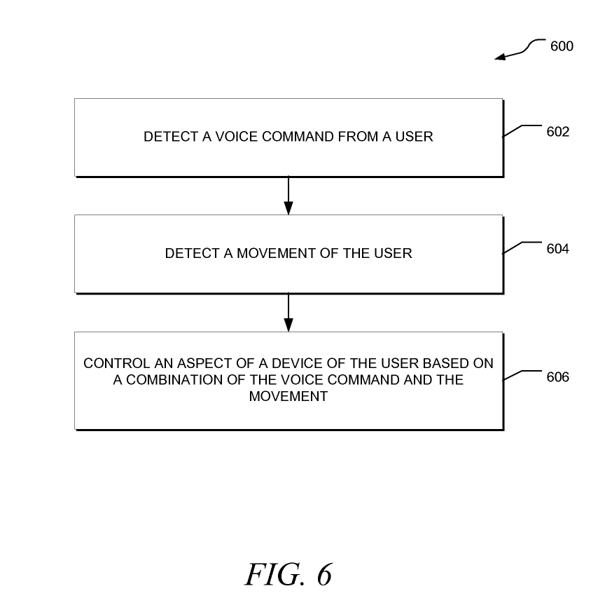

FIG. 6 is a flow chart illustrating example operations of a method 600 of controlling an aspect of a device of a user based on a combination of a voice command and a movement. In various embodiments, the method 600 is implemented by the modules 202-210 of FIG. 2. At operation 602, the detection module 202 detects a voice command of the user. For example, the detection module 202 may receive a notification from one or more of a plurality of devices of the user that the user has spoken a particular word that is associated with a command that is to be executed within an application executing on one of the plurality of the devices. The user or an administrator may establish the association between particular words and particular application commands. In various embodiments, the interpretation module 204 may determine the correspondences between voice commands and application commands.

At operation 604, the detection module 202 may detect a movement of the user. For example, the detection module 202 may detect a nodding of the user, an eye movement of the user, or a gesture of the user, as described above.

At operation 606, the command module 206 may control an aspect of a device of the user based on a combination of the voice command and the movement. For example, the command module 206 may issue a command to a device to turn on or off, change a volume, or otherwise control a setting of the device based on the user stating a particular word and making a gesture. Thus, a user may increase a volume of an iPhone of the user by saying the word “volume” and making an upward arm movement. Or the command module 206 may issue a command to an application executing on the device to perform a desired action of the user (e.g., based on an analysis of the voice command and the movement by the interpretation module 204). Thus, the command module 206 may control a device of the user based on combinations of voice commands and movements of the user.

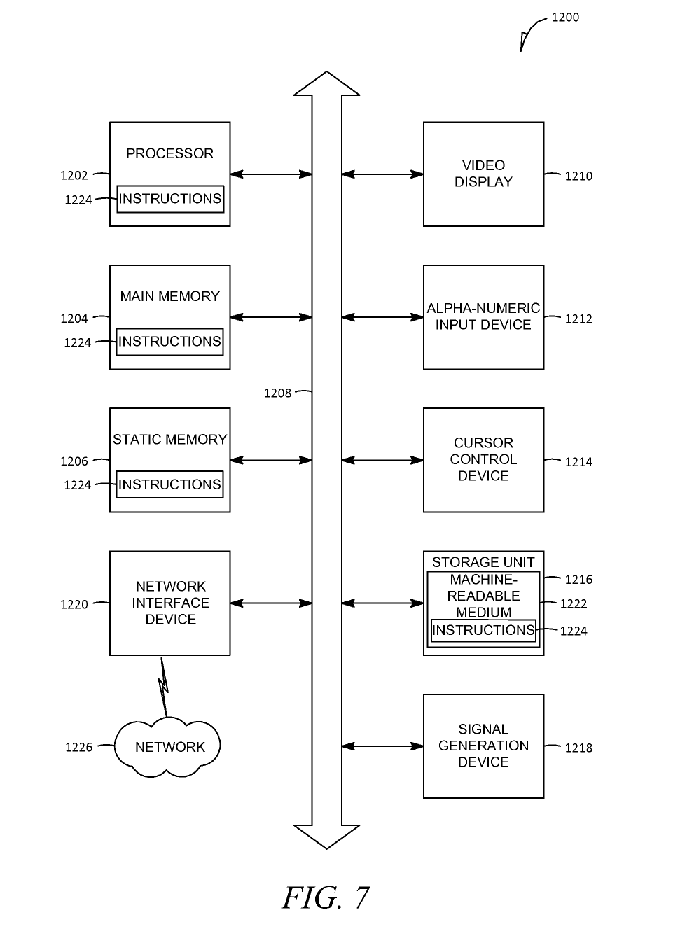

FIG. 7 is a block diagram of a machine in the example form of a computer system 1200 within which instructions for causing the machine to perform any one or more of the operations or methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a storage unit 1216, a signal generation device 1218 (e.g., a speaker) and a network interface device 1220.

The storage unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 1224 may further be transmitted or received over a communications network 1226 using a transmission medium. The network 1226 may be one of the networks 1220. The instructions 1224 may be transmitted using the network interface device 1220 and any one of a number of well-known transfer protocols (e.g., Hyper Text Transfer Protocol (HTTP)). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
detecting that a user is interacting with an application executing on a device of the user;
receiving a notification that the device has detected a movement of the user;
determining that the movement represents an intention of the user to issue a command to the application; and
issuing the command to the application based on the movement, wherein the issuing of the command to the application is performed by a processor of a machine.

2. The method of claim 1, wherein the device is worn on the face of the user and the movement of the user is an eye movement of the user.

3. The method of claim 1, wherein the user is a first user of a social networking system, the application includes a user interface for presenting content items to the user on the device, and the command is to share at least one of the content items with a second user of the social networking system.

4. The method of claim 1, wherein the user is a first user of a social networking system, the application includes a user interface for presenting information pertaining to a second user of the social networking system, and the command to the application is to request a connection between the first user and the second user with respect to the social networking system.

5. The method of claim 1, further comprising receiving a mapping of a plurality of movements to a plurality of respective commands and wherein the determining that the movement represents an intention of the user to issue the command to the application is based on an analysis of the mapping.

6. The method of claim 4, further comprising selecting the second user from a plurality of additional users of the social networking system based on similarities between a profile of the user and a plurality of profiles corresponding to the additional users.

7. The method of claim 6, wherein the similarities pertain to at least one of job titles, employers, educational degrees attained, educational background, organizational affiliations, personal interests, affiliated organizations, special-interest groups, and relationships.

8. A system comprising:
one or more processors configured to, based on an execution of one or more instructions contained in a memory:
detect that a user is interacting with an application executing on a device of the user;
receive a notification that the device has detected a movement of the user;
determine that the movement represents an intention of the user to issue a command to the application; and
issue the command to the application based on the movement.

9. The system of claim 8, wherein the device is worn on the face of the user and the movement of the user is an eye movement of the user.

10. The system of claim 8, wherein the user is a first user of a social networking system, the application includes a user interface for presenting content items to the user on the device, and the command is to share at least one of the content items with a second user of the social networking system.

11. The system of claim 8, wherein the user is a first user of a social networking system, the application includes a user interface for presenting information pertaining to a second user of the social networking system, and the command to the application is to request a connection between the first user and the second user with respect to the social networking system.

12. The system of claim 8, further comprising receiving a mapping of a plurality of movements to a plurality of respective commands and wherein the determining that the movement represents an intention of the user to issue the command to the application is based on an analysis of the mapping.

13. The system of claim 12, further comprising selecting the second user from a plurality of additional users of the social networking system based on similarities between a profile of the user and a plurality of profiles corresponding to the additional users.

14. The system of claim 13, wherein the similarities pertain to at least one of job titles, employers, educational degrees attained, educational background, organizational affiliations, personal interests, affiliated organizations, special-interest groups, and relationships.

15. A non-transitory machine-readable medium embodying a set of instructions that, when executed by a processor, cause the processor to perform operations, the operations comprising:
detecting that a user is interacting with an application executing on a device of the user;
receiving a notification that the device has detected a movement of the user;
determining that the movement represents an intention of the user to issue a command to the application; and
issuing the command to the application based on the movement.

16. The non-transitory machine-readable medium of claim 15, wherein the device is worn on the face of the user and the movement of the user is an eye movement of the user.

17. The non-transitory machine-readable medium of claim 15, wherein the user is a first user of a social networking system, the application includes a user interface for presenting content items to the user on the device, and the command is to share at least one of the content items with a second user of the social networking system.

18. The non-transitory machine-readable medium of claim 15, wherein the user is a first user of a social networking system, the application includes a user interface for presenting information pertaining to a second user of the social networking system, and the command to the application is to request a connection between the first user and the second user with respect to the social networking system.

19. The non-transitory machine-readable medium of claim 15, further comprising receiving a mapping of a plurality of movements to a plurality of respective commands and wherein the determining that the movement represents an intention of the user to issue the command to the application is based on an analysis of the mapping.

20. The non-transitory machine-readable medium of claim 18, further comprising selecting the second user from a plurality of additional users of the social networking system based on similarities between a profile of the user and a plurality of profiles corresponding to the additional users.
